(19) United States
(12) Patent Application Publication
(10) Pub. No.: US 2020/0032567 A1
(43) Pub. Date: Jan. 30, 2020

(54) PUSH-PULL DOOR/WINDOW

(71) Applicant: Shenzhen Hopo Window Control Technology Co., Ltd., Guangdong (CN)

(72) Inventors: Shupeng Li, Guangdong (CN); Xiaojuan Tan, Guangdong (CN); Ping He, Guangdong (CN); Zhou Lin, Guangdong (CN)

(21) Appl. No.: 16/337,045

(22) PCT Filed: Aug. 10, 2017
(86) PCT No.: PCT/CN2017/096810

§ 371 Date: Mar. 27, 2019

(30) Foreign Application Priority Data
Jul. 14, 2017 (CN) 201710575492.0

(51) Int. Cl. E05D 13/00; E05D 15/06; E06B 3/46; E06B 5/20

(52) U.S. Cl. CPC E05D 13/00; E05D 15/0626; E06B 3/4609; E05Y 2900/148; E06B 3/4636; E05Y 2900/132; E06B 5/205

(57) ABSTRACT

Disclosed is a sliding door or window. The sliding door or window includes a door/window frame, a swing fastening mechanism is disposed at a lower end of a side of the door/window frame, and a locking structure is mounted on an upper end of the side of the door/window frame. The swing fastening mechanism and the locking structure are each provided with a snakelike groove inside which a shaft operative to slide along a groove orientation is arranged. A handle disposed on the door/window frame is operative to drive the shaft to slide in the snakelike groove, thereby forcing the swing fastening mechanism or/and the locking structure to swing.

### TECHNICAL FIELD

The present disclosure relates to the technical field of door and window manufacturing, and more particularly relates to a sliding door or window provided with a swing fastening mechanism.

### BACKGROUND

Sliding doors or windows have been widely used, such as a sliding door mounted between a kitchen and a living room in home, a partition door in an office, a balcony door, a factory window, a home window, and so on. A sliding door or window mainly includes a door or window body. In a better product, a pulley is arranged under the door or window body to operate in cooperation with a guide rail disposed on the door or window, thereby making opening the door/window be a labor-saving and convenient operation. Such form of product has many advantages over the traditional door or window products. Nevertheless, there exists a big drawback in that a certain amount of leeway may be present between the door/window and the frame or between the pulley and the guide rail, such that a crashing sound may occur when a strong wind is blowing or an external force is colliding to the door/window. Moreover, a long-term collision is likely to break the glass or damage the door/window. Meanwhile, the sound insulation effect is not satisfactory due to insufficient sealing. The technical problem sought to be solved by the present disclosure is therefore to ensure the sealing and fastening performances between the door/window body and the door/window frame.

### SUMMARY

The purpose of the present disclosure is to solve the above-mentioned technical problem. A sliding door or window is provided and has the advantages of reasonable structure, good sound insulation effect and good fastening property.

To solve the above-mentioned technical problem, the present disclosure adopts a technical solution described below.

A sliding door or window is provided, including a door/window frame a lower end of a side of which is provided with a swing fastening mechanism and an upper end of the side of which is mounted with a locking structure, where the swing fastening mechanism and the locking structure are respectively provided with a snakelike groove inside which a shaft which may slide in a groove direction is provided, and a handle disposed on the door/window frame is operative to drive the shaft to slide in the snakelike groove so as to force the swing fastening mechanism or/and the locking structure to swing.

Preferably, the swing fastening mechanism includes a base configured to be fixedly connected to a door or window and further includes a pendulum member a lower end of which is hinged on the base, an upper end of the pendulum member is provided with a snakelike groove inside which a drive shaft slidable in the snakelike groove is provided, the drive shaft is connected to a sliding block whose upper end is drivingly connected to a handle of the door or window and which can drive the drive shaft to slide in the snakelike groove so as to force the pendulum member to swing around a hinge axis, and a lower end of the pendulum member is connected to a pulley configured to be mounted on a guide rail on a lower side of the door or window; and the locking structure includes a right-angled connection casing configured to be mounted on the door or window, a fixed base, a swing piece, a linkage piece, a first connection assembly, a second connection assembly, and at least one transmission belt which are configured to be mounted on the door or window.

The fixed base is provided with a first cavity body, one end of the swing piece is provided with a guide wheel configured to be mounted on the door or window and to be engaged with a guide rail on an upper side of the door/window frame, and another end of the swing piece extends into the first cavity body of the fixed base and is hinged in the first cavity body; the end of the swing piece that extends into the first cavity body is further provided with a snakelike groove; a limit shaft movable along the snakelike groove is disposed inside the snakelike groove; the linkage piece is connected to the limit shaft and may move together with the limit shaft along the snakelike groove so that the swing piece is forced to swing around the hinge axis during the moving process; and the first connection assembly is fixedly connected to an end of the linkage piece facing away from the limit shaft.

The right-angled connection casing is provided with a second cavity body for the transmission belt to extend through; and after the transmission belt extends through the second cavity body of the right-angled connection casing, two ends of the transmission belt are respectively connected to the first connection assembly and the second connection assembly so that a linkage of the transmission belt, the first connection assembly and the second connection assembly is achieved.

Two swing fastening mechanisms are provided at the lower end of the side of the door/window frame, two locking structures are mounted at the upper end of the side of the door/window frame, and the two swing fastening mechanisms and the two locking structures form a linkage structure with an opening lower end via a connection member.

Further, in the swing fastening mechanism, the swing fastening mechanism further includes a mounting bracket, the mounting bracket is provided with a cavity in which the pendulum member may be inserted and swing to a certain extent and is further provided with a straight groove extending through the cavity, two ends of the drive shaft are movably snap-loaded to the straight groove, a lower end of the sliding block is inserted into the cavity and connected to the drive shaft, and the lower end of the pendulum member extends outside the cavity and is externally connected to the pulley; the pendulum member is provided with a first hinge hole, a lower end of the mounting bracket is provided with a second hinge hole, a lower end of the base is provided with a third hinge hole, and the pendulum member, the mounting bracket and the base are engaged with the three hinge holes via a rotating shaft.

In the locking structure, the swing piece includes two identical swing plates and a square shaft disposed between the two swing plates; the swing plates are fixedly connected to the square shaft to achieve a linkage of the swing plates and the square shaft; the swing plates and the square shaft are hinged in the first cavity body of the fixed base via a rotating shaft; one end of the square shaft extends outside the swing plate and is provided with the guide wheel configured to be mounted on the door or window; the snakelike groove is provided at one end of the swing plate facing away from the square shaft; and the linkage piece is further disposed between the two swing plates, and after the limit shaft extends through the linkage piece, two ends of the limit shaft are disposed in the snakelike grooves of the swing plates to achieve that the limit shaft move along the snakelike groove together with the linkage piece.

Further, in the swing fastening mechanism, the lower end of the sliding block is provided with a U-shaped through groove, the upper end of the pendulum member is provided with a sheet-shaped lug insertable into the U-shaped through groove, the snakelike groove is disposed on the lug, and a portion of the mounting bracket corresponding to the lug is provided with a swing window for ensuring a sufficient swinging stroke of the lug during a swinging process; in the locking structure, the first connection assembly includes a first connection piece and a first transmission piece which are fixedly connected to the linkage piece; the second connection assembly includes a second connection piece and a second transmission piece which are fixedly connected to each other; the first transmission piece and the second transmission piece are connected via the flexible transmission belt to achieve a linkage of the first transmission piece, the transmission belt and the second transmission piece; one end of the right-angled connection casing is provided with a first sliding groove along which the first transmission piece may move; and an other end of the right-angled connection casing is provided with a second sliding groove along which the second transmission piece may move.

Further, a mounting groove is disposed on one side of the base close to the pendulum member, and the mounting bracket has at least a portion that may be snap-loaded to the mounting groove.

Further, a guide groove is disposed at an upper end of one side of the base close to the mounting bracket, the sliding block is provided with a guide portion that for snap fit engagement with the guide groove, the mounting groove is disposed below the guide groove, and a limit structure for engaging the mounting bracket is disposed between the guide groove and the mounting groove.

Further, the guide groove and the mounting groove are both square grooves and are consistent in direction, a width of the guide groove is smaller than a width of the mounting groove, the limit structure is a limit platform protruding outside the guide groove, the mounting bracket is in a quadrilateral cylindrical shape and has a side surface abutted against a bottom of the mounting groove to be engaged with the base, and one end of the mounting bracket abuts against a boss protruding outside the guide groove.

Further, the pulley is mounted at the lower end of the pendulum member via a bracket.

Further, the mounting groove is provided with a receiving groove which is equivalent in length to the straight groove and is used for one end of the drive shaft to slide in.

Further, the sliding block is provided with a shock-absorbing muffling spacer; and a first shock-absorbing muffling spacer is disposed at one end of the first connection assembly facing away from the right-angled connection casing, and a second shock-absorbing muffling spacer is disposed at one end of the second connection assembly facing away from the right-angled connection casing.

Further, the pulley is a U-shaped groove wheel made of an elastic material, and the transmission belt is a flexible steel belt.

In summary, the swing fastening mechanism provides the base configured to be fixedly connected to the door or window, the pendulum on the base is hinged on the lower end of the base, the upper end of the pendulum member is provided with the snakelike groove inside which the drive shaft slidable in the snakelike groove is provided, the drive shaft is connected to the sliding block whose upper end is drivingly connected to the handle of the door or window, the sliding block can drive the drive shaft to slide in the snakelike groove so as to force the pendulum member to swing around an axis of an articulated shaft, and the lower end of the pendulum member is connected to the pulley configured to be mounted on the guide rail of the door or window. In response to rotating the handle of the door, the guide rail is tightened by the pulley via the pendulum member, and meanwhile a counterforce of the guide rail to the pulley forces the base to generate a certain displacement. Thereby, the door/window and the door/window frame are driven to be tightly fastened with each other, and good fastening and sound insulation effects are achieved. In the locking structure, the linkage piece moves in the snakelike groove of the swing piece so that the swing piece is forced to swing. During the swinging process, the door or window fixedly connected to the fixed base and the right-angled connection casing presses on the door or window frame to achieve sealing and unsealing of the door or window and avoid collision between the door or window and the mounting frame thereof. Thus, the sealing and sound insulation effect of the door or window is improved. Two swing fastening mechanisms are provided at the lower end of the side of the door/window frame, two locking structures are mounted at the upper end of the side of the door/window frame, and the two swing fastening mechanisms and the two locking structures form a linkage structure with an opening at the lower end via a connection member. Therefore, by rotating the handle of the door or window, the two swing fastening mechanisms and the two locking structures are linked to achieve the sealing and fastening of the door or window.

### BRIEF DESCRIPTION OF DRAWINGS

The present disclosure will be further described below in conjunction with the drawings.

FIG. 1 is a perspective view of a swing fastening mechanism provided in the present disclosure;

FIG. 2 is an exploded view of a swing fastening mechanism provided in the present disclosure;

FIG. 3 is a cross-sectional view of a swing fastening mechanism provided in the present disclosure;

FIG. 4 is another perspective view of a swing fastening mechanism viewed from another direction provided in the present disclosure;

FIG. 5 is a perspective view of an assembly structure of a mounting bracket and a base in a swing fastening mechanism provided in the present disclosure;

FIG. 6 is a perspective view of a swing fastening mechanism with the mounting bracket removed provided in the present disclosure;

FIG. 7 is a top view of a mounting bracket in a swing fastening mechanism provided in the present disclosure;

FIG. 8 is a perspective view of a base in a swing fastening mechanism provided in the present disclosure;

FIG. 9 is a fitting structural diagram of a swing fastening mechanism mounted on a window frame provided in the present disclosure;

FIG. 10 is a structural diagram of a swing fastening mechanism, after being mounted on a window frame, fitting with a base of the window provided in the present disclosure;

FIG. 11 is a structural diagram of a window frame in an unlocked state after a swing fastening mechanism is mounted on the window frame provided in the present disclosure;

FIG. 12 is a structural diagram of a window frame in a locked state after a swing fastening mechanism is mounted on the window frame provided in the present disclosure;

FIG. 13 is an overall structural diagram of a locking structure provided in the present disclosure;

FIG. 14 is a structural diagram of a locking structure provided in the present disclosure;

FIG. 15 is an assembly diagram of parts of the locking structure provided in the present disclosure;

FIG. 16 is a diagram of a working principle of a locking structure provided in the present disclosure;

FIG. 17 is a diagram of a working principle of a locking structure provided in the present disclosure;

FIG. 18 is a diagram of a locking structure in an unlocked state provided in the present disclosure;

FIG. 19 is a diagram of a locking structure in a locked state provided in the present disclosure;

FIG. 20 is a schematic diagram of a connection structure of a locking structure of a swing fastening mechanism provided in the present disclosure; and

FIG. 21 is a partial cut-away perspective view of an assembled relationship provided by the present disclosure.

### DETAILED DESCRIPTION

Embodiments of the present disclosure are described in detail below, and examples of the embodiments are illustrated in the drawings, where the same or similar reference numerals indicate the same or similar elements or elements having the same or similar functions. The embodiments described below with reference to the drawings are exemplary, intended to explain the present disclosure, and not to be construed as limiting the present disclosure.

In the description of the present disclosure, it is to be understood that the orientation or position relationships indicated by terms “center”, “longitudinal”, “lateral”, “length”, “width”, “thickness”, “above”, “below”, “front”, “back”, “left”, “right”, “vertical”, “horizontal”, “top”, “bottom”, “inside”, “outside”, “clockwise”, “counterclockwise”, etc. are based on the orientation or position relationships shown in the drawings, merely for facilitating description of the present disclosure and simplifying description, and do not indicate or imply that the apparatus or element referred to has a specific orientation and is constructed and operated in a specific orientation, and thus it is not to be construed as limiting the present disclosure.

Moreover, terms like “first” and “second” are for description only and are not to be construed as indicating or implying relative importance or implicitly indicating the number of technical features as indicated. Thus, a feature defined as a “first” feature or a “second” feature may explicitly or implicitly include one or more of this feature. As used herein, the term “plurality” is defined as two or more, unless otherwise expressly specified and limited.

In the present disclosure, unless otherwise expressly specified and limited, terms like “mounted”, “connected to each other”, “connected” or “fixed” are to be construed in a broad sense, for example, as permanently connected, detachably connected or integrated; mechanically connected or electrically connected; directly connected or indirectly connected via an intermediate medium; or internally connected between two elements. For those of ordinary skill in the art, the above terms can be construed according to specific circumstances in the present disclosure.

In the present disclosure, unless otherwise expressly specified and limited, when a first feature is described as “above” or “below” a second feature, the first feature and the second feature may be in direct contact, or be in contact via another feature between the two features. Moreover, when the first feature is described as “on”, “above” or “over” the second feature, the first feature is right on, above or over the second feature or the first feature is obliquely on, above or over the second feature, or the first feature is at a higher level than the second feature. When the first feature is described as “under”, “below” or “underneath” the second feature, the first feature is right under, below or underneath the second feature or the first feature is obliquely under, below or underneath the second feature, or the first feature is at a lower level than the second feature.

The present disclosure will be further described in detail in conjunction with the drawings and specific embodiments.

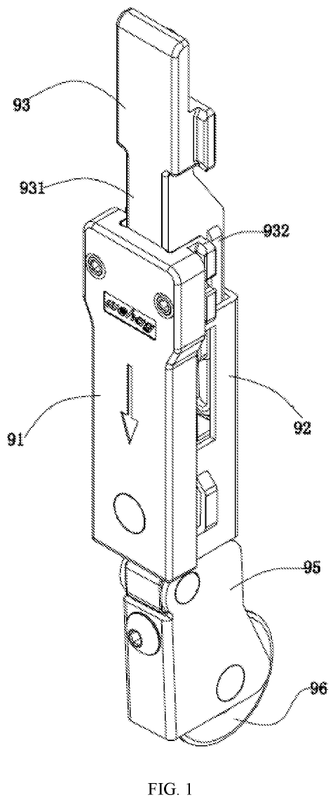

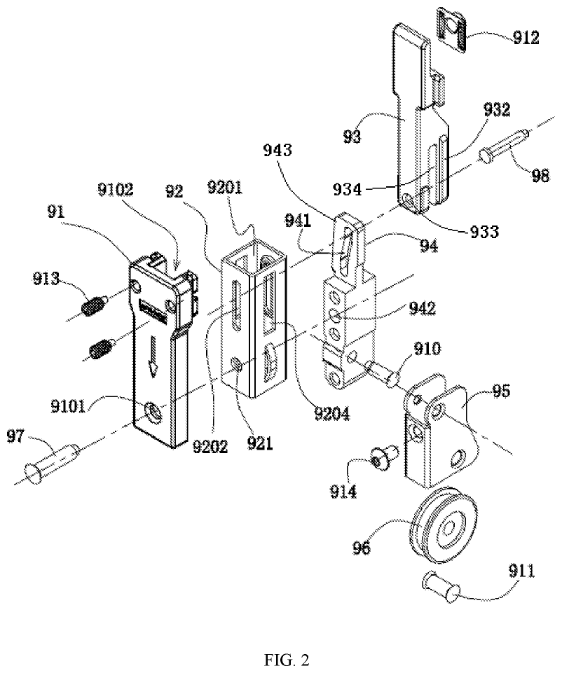

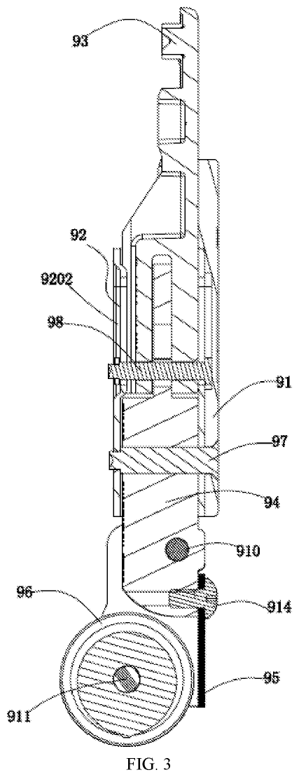

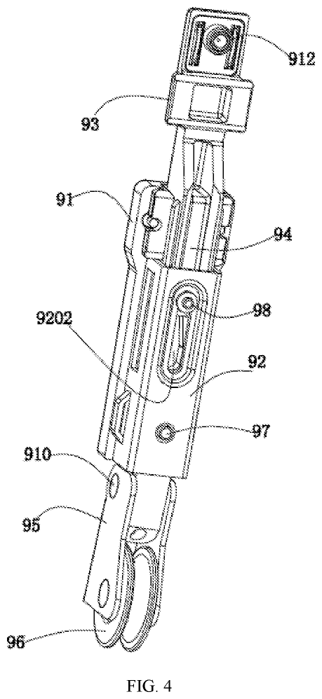

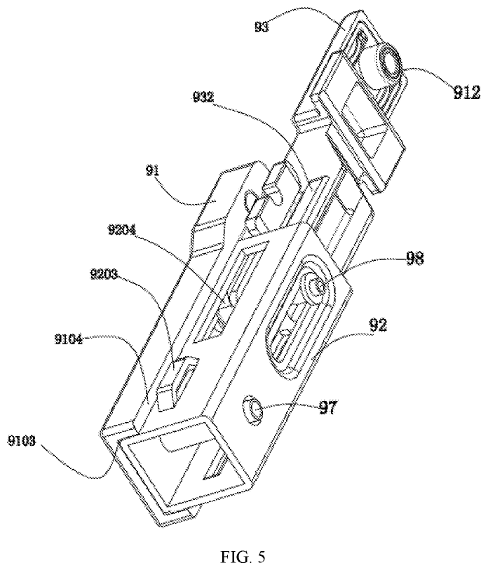

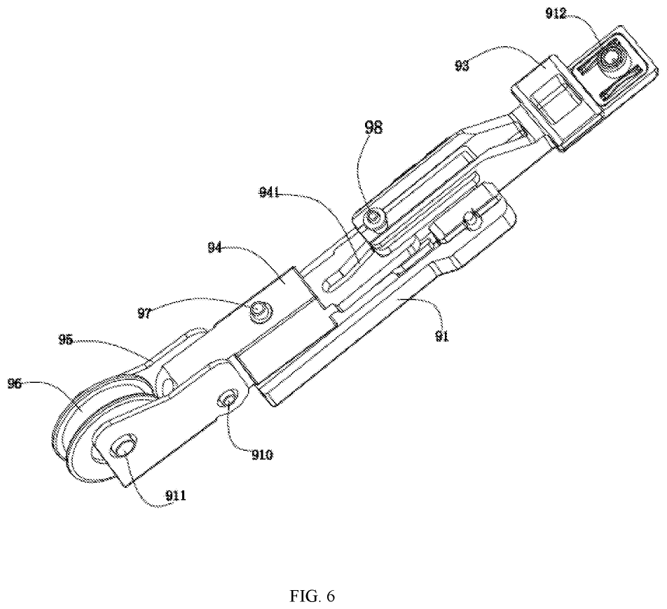

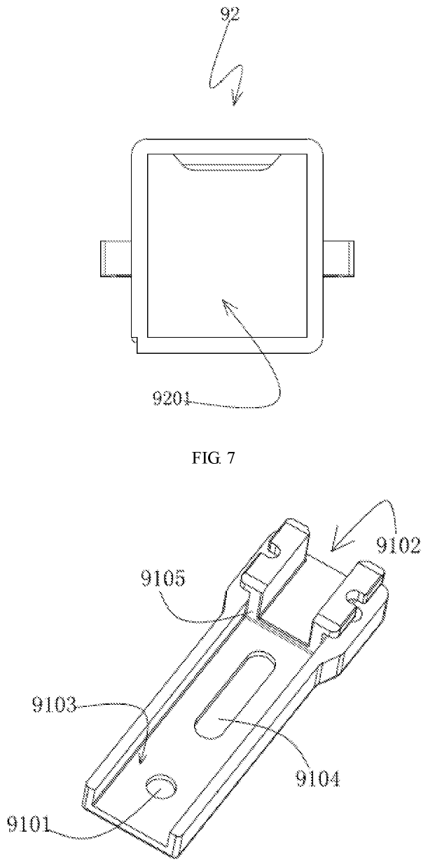

Referring to FIGS. 1 to 8, they show a swing fastening mechanism 9100 configured to be mounted on a door or window. The swing fastening mechanism 9100 includes a base 91 configured to be fixedly connected to the door or window. The base 91 is provided with a profile snap groove 9106 for snap fit of a door or window profile. The swing fastening mechanism 9100 further includes a pendulum member 94 a lower end of which is hinged on the base 91. An upper end of the pendulum member 94 is provided with a snakelike groove 941 inside which a drive shaft 98 is disposed through the snakelike groove and is slidable in the snakelike groove. The drive shaft 98 is connected to a sliding block 93 whose upper end is drivingly connected to a handle of the door or window, and the sliding block 93 can drive the drive shaft 98 to slide in the snakelike groove 941 so as to force the pendulum member 94 to swing around an axis of an articulated shaft. A shock-absorbing muffling spacer 912 is disposed on the sliding block 93. Since the snakelike groove is disposed on the pendulum member 94, the pendulum member 94 may generate a certain lateral displacement in response to sliding the drive shaft in the snakelike groove. Due to the obstruction of the articulated shaft of the pendulum member, the pendulum member 94 swings around the axis of the articulated shaft and thus drives a pulley 96 to swing. In response to being limited by the displacement, the pulley 96 generates a reversed force to the pendulum member 94, and thereby the base 91 is forced to generate a certain displacement. A lower end of the pendulum member 94 is connected to the pulley 96 configured to be mounted on a guide rail of the door or window. The pulley 96 is mounted at the lower end of the pendulum member 94 via a bracket 95. Specifically, the bracket 95 is mounted at the lower end of the pendulum member 94 via a pin shaft 910 and a screw 914, and the pulley 96 is mounted on the bracket 95 via a bracket shaft 911. In an exemplary embodiment, the pulley 96 is a U-shaped groove wheel made of an elastic material.

Further, the swing fastening mechanism 9100 further includes a mounting bracket 92. The mounting bracket 92 is provided with a cavity 9201 through which the pendulum member 94 may be inserted, and the cavity 9201 may be also available to the pendulum member 94 for swinging to a certain extent. The mounting bracket 92 is further provided with a straight groove 9202 extending through the cavity 9201. Two ends of the drive shaft 98 are movably snap-fitted to the straight groove 9202. A lower end of the sliding block 93 is inserted into the cavity 9201 and connected to the drive shaft 98 via a hole 933 disposed at the lower end of the sliding block 93. For better balance, the lower end of the sliding block 93 is provided with a U-shaped through groove 934, and the upper end of the pendulum member 94 is provided with a sheet-shaped lug 943 insertable into the U-shaped through groove 934. The snakelike groove 941 is disposed on the lug 943 so that the lug 943 may slide in the U-shaped through groove 934. The lower end of the pendulum member 94 extends outside the cavity 9201 and is connected to the bracket 95 and the pulley 96. The middle of the pendulum member 94 is provided with a first hinge hole 942, a lower end of the mounting bracket 92 is provided with a second hinge hole 921, a lower end of the base 91 is provided with a third hinge hole 9101, and the pendulum member 94, the mounting bracket 92 and the base 91 are connected via a rotating shaft 97 mated with the three hinge holes. In this way, the pendulum member 94 can swing to some extent around the rotating shaft 97 in the cavity 9201 of the mounting bracket 92. To ensure a good swinging effect and a sufficient swinging travel of the lug 943 during the swinging process, a portion of the mounting bracket 92 corresponding to the lug 943 is provided with a swing window 9204, so that a part of the lug 943 can be swung outside the swing window 9204 during the swinging process of the pendulum member 94.

Further, a mounting groove 9103 is disposed on one side of the base 91 close to the pendulum member 94. A guide groove 9102 is disposed at an upper end of one side of the base 91 close to the mounting bracket 92. The sliding block 93 is provided with a guide portion 931 for snap-fitting with the guide groove 9102. The mounting groove 9103 is disposed below the guide groove 9102, and a limit structure for engaging the mounting bracket 92 is disposed between the guide groove 9102 and the mounting groove 9103. Specifically, the limit structure is a limit platform 9105 protruding outside the guide groove 9102.

Further, the guide groove 9102 and the mounting groove 9103 are both square grooves and are consistent in direction, and a width of the guide groove 9102 is smaller than a width of the mounting groove 9103. The mounting bracket 92 is in a quadrilateral cylindrical shape and has a side surface abutted against a bottom of the mounting groove 9103 for snap-fitting engagement. One end of the mounting bracket 92 abuts against a boss protruding outside the guide groove 9102. The sliding block 93 is further provided with a guide boss 932 which is snap-fitted with an opening rim of the guide groove 9102. In this way, in response to inserting the sliding block 93 into the mounting bracket 92, the guide portion 931 of the sliding block 93 is attached to the bottom wall of the guide groove 9102 on the base 91, and the guide boss 932 is attached to the opening rim of the guide groove 9102 on the base 91. The profile snap grooves 9106 are symmetrically disposed on the base 91 outside the guide groove 9102.

Further, a receiving groove 9104 is disposed in the mounting groove 9103, The length of the receiving groove 9104 is equivalent to the length of the straight groove 9202, and the receiving groove 9104 is used for one end of the drive shaft 98 to slide in. The receiving groove 9104 is disposed to prevent the drive shaft from interfering with the base 91 during the movement.

Further, the sliding block 93 is provided with a shock-absorbing muffling spacer 912 for preventing the noise generated by friction with the door or window during the movement of the sliding block 93.

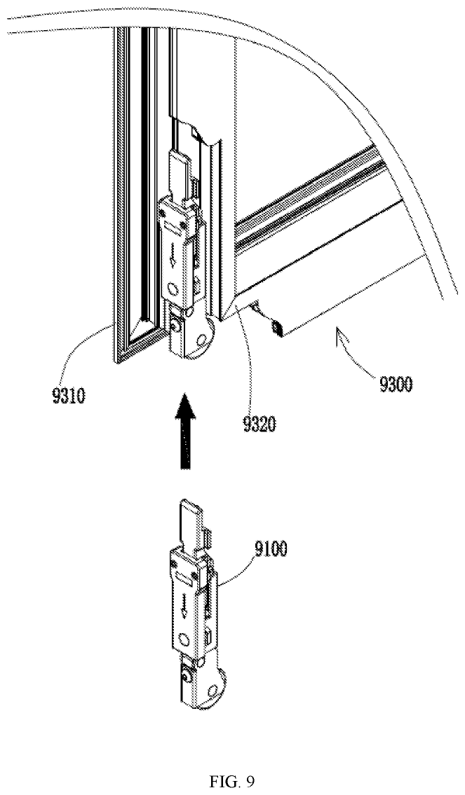

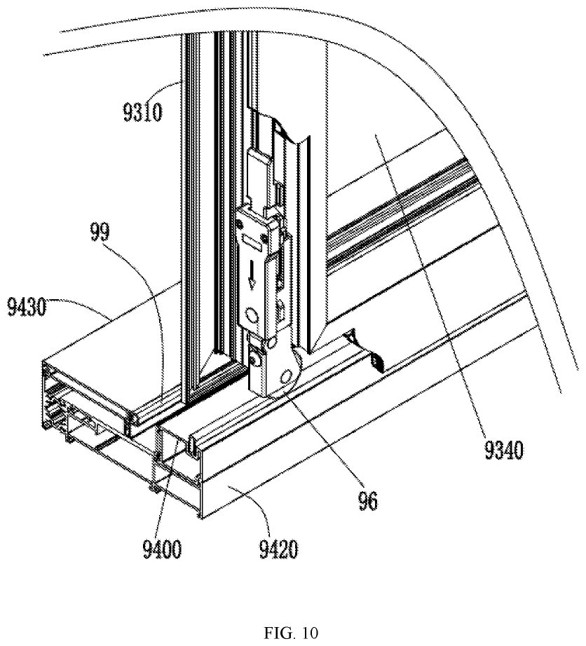

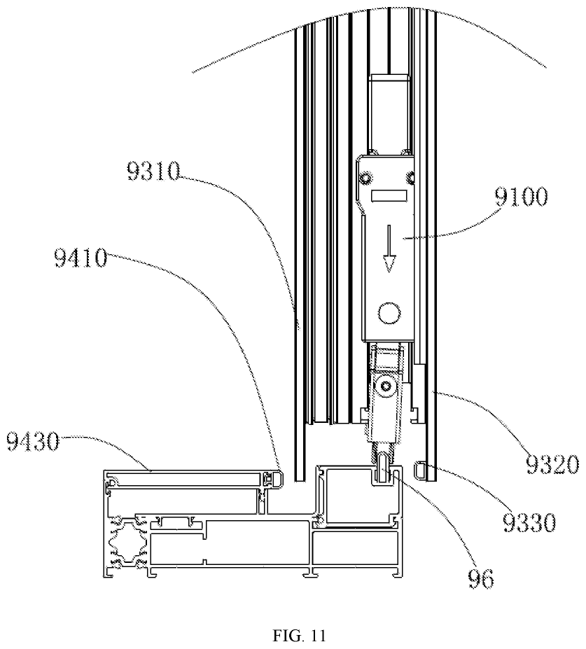

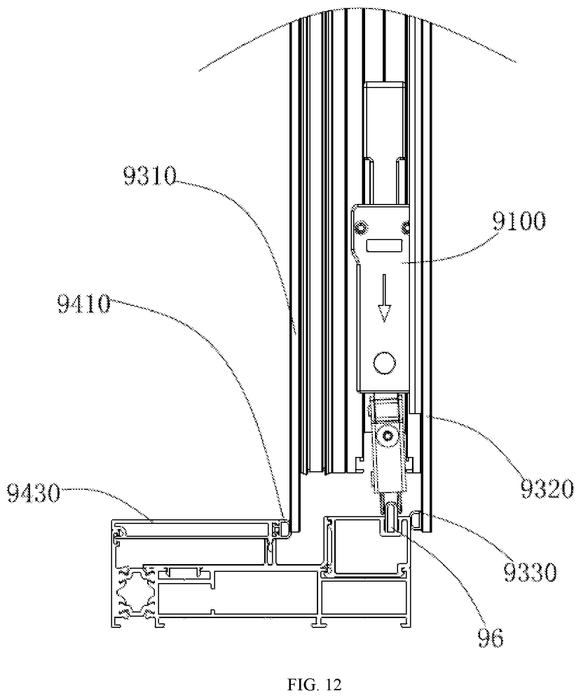

Referring to FIGS. 9 to 12, the swing fastening mechanism 9100 used in a sliding window of the embodiment 1 is mounted on a window, and the window includes a window base 9430, a window frame 9300, a window glass 9340, a window guide rail 9400, and an outer end surface 9420 of the base. The window frame 9300 includes an inner window frame 9310, an outer window frame 9320, and a sealing strip 99 that can be sealingly engaged with the outer end surface 9420 of the base and an outer end surface of the inner window frame 9310. The swing fastening mechanism 9100 is pushed upward from the bottom of the window frame 9300, and the profile on the window frame 9300 is engaged with the profile snap groove 9106 on the base 91, so that the swing fastening mechanism 9100 is snap-fitted on the window frame 9300. After sliding to a proper position, the swing fastening mechanism 9100 is fastened to the window frame 9300 via a headless screw 913. At this time, the pulley 96 is just fitted with the window guide rail 9400, and the sliding block 93 on the swing fastening mechanism 9100 is drivingly connected to a handle (not shown) on the window via a linkage mechanism (not shown). In response to rotating the handle on the window in one direction, the linkage mechanism drives the sliding block 93 to slide downward to drive the pendulum member 94 to swing around the rotating shaft 97, so that the pulley 96 connected to the pendulum member 94 swings toward the side of the outer window 9320. The pulley 96 generates a reverse thrust due to the limit of the window guide rail 9400, and the reverse thrust is transmitted to the base 91 via the pendulum member 94, so that the window frame 9300 fixedly connected to the base 91 moves toward the side of the inner window frame 9310. In response to determining that the outer end surface 9420 of the base and the outer end surface of the inner window frame 9310 are tightly pressed with the sealing strip 99, the fastening and sealing functions are achieved. On the contrary, in response to rotating the handle on the window in the other direction, the linkage mechanism drives the sliding block 93 to slide upward, and the window frame 9300 moves towards the side of the outer window frame 9320. In response to determining that the outer end surface 9420 of the base and the outer end surface of the inner window frame 9310 are separated from the sealing strip 99, the locking is released, and the window can be pushed and pulled at will.

Of course, with the same principle, the swing fastening mechanism 9100 of the embodiment 1 may also be used in the sliding door. The principles of fastening and sealing are as above, and will not be described in detail again.

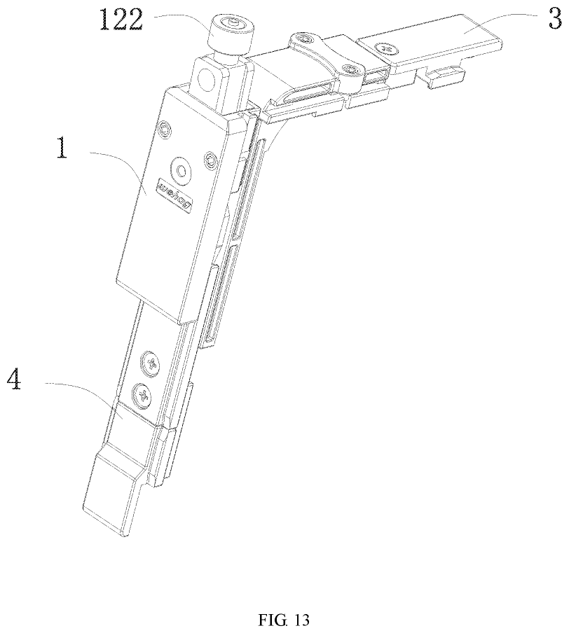

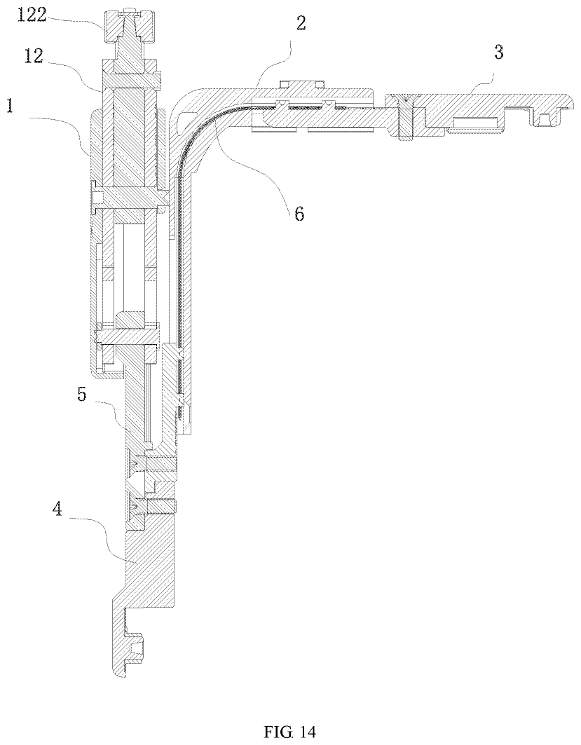

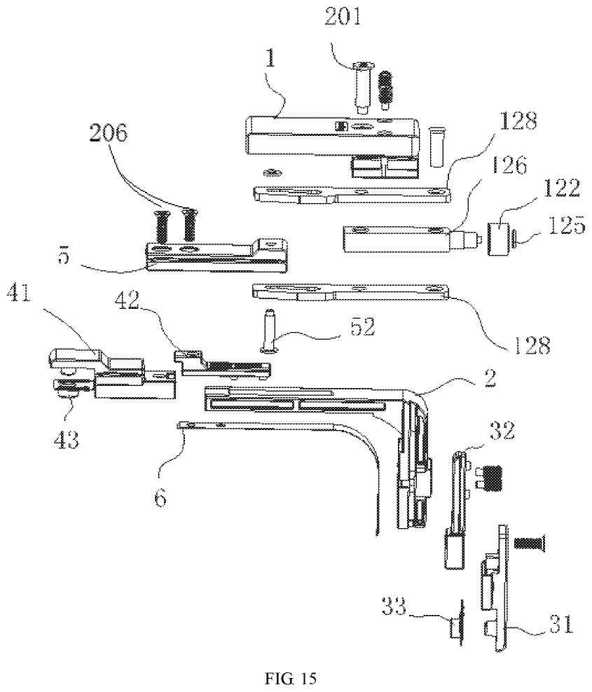

To better apply the swing fastening mechanism 9100 to the door or window, in the present disclosure, as shown in FIGS. 13 to 19, a locking structure 9200 is further disposed on the door or window frame. Specifically, the locking structure 9200 includes a right-angled connection casing 2 configured to be mounted on the door or window, a fixed base 1, a swing piece 12, a linkage piece 5, a first connection assembly 4, a second connection assembly 3 and at least one flexible transmission belt 6 which are configured to be mounted on the door or window. In the embodiment of the present disclosure, three flexible steel belts are adopted.

The fixed base 1 is provided with a first cavity body. One end of the swing piece 12 is provided with a guide wheel configured to be mounted on a guide rail on an upper side of the door or window frame, and the other end of the swing piece 12 extends into and is hinged in the first cavity body of the fixed base 1. The swing piece 12 includes two identical swing plates 128 and a square shaft 126 disposed between the two swing plates 128. The two swing plates 128 are symmetrically disposed on two sides of one end of the square shaft. The swing plates 128 and the square shaft 126 are screwed together by a first screw 206 and are further hinged in the first cavity body of the fixed base 1 via a rotating shaft 201. In this way, it can be realized that the swing plates 128 and the square shaft 126 is fixedly connected into a whole, and the whole composed of the swing plates 128 and the square shaft 126 can rotate around the rotation shaft 201. One end of the square shaft 126 extends out of the swing plates 128, and the guide wheel 122 is disposed at this end. One end of the guide wheel 122 facing away from the square shaft 126 is further provided with a muffling spacer 125 that may reduce noise generated by friction or impact between the end of the guide wheel 122 and the door or window frame during rolling of the guide wheel 122. Each of the swing plates 128 has one end not attached to the square shaft 126, and this end of each of the swing plates 128 is provided with a snakelike groove 130. A linkage piece 5 is further disposed between the two swing plates 128. After a limit shaft 52 extends through the linkage piece 5, two ends of the limit shaft 52 are disposed in the snakelike grooves 130 of the swinging plates 128 to achieve that the limit shaft 52 move along the snakelike grooves 130 together with the linkage piece 5. Moreover, during the movement, the limit shaft 52 and the linkage piece 5 may just move linearly. However, the grooves of the snakelike grooves 130 are similar to an “S” shape, so the swinging plates 128 and the square shaft 126 are forced to rotate around the rotating shaft 201 during the linear movement of the limit shaft 52 and the linkage piece 5 in the cavity of the fixed base 1.

Further, the first connection assembly 4 is fixedly connected to an end of the linkage piece 5 facing away from the limit shaft 52. The first connection assembly includes a first connection piece 41 and a first transmission piece 42. The first connection piece 41 is screwed onto the linkage piece 5 via a screw 206, and the first transmission piece 42 is screwed onto the linkage piece 5 via a screw, so that it is realized that the first connection piece 41 and the first transmission piece 42 are fixedly connected to the linkage piece 5. The second connection assembly 3 includes a second connection piece 31 and a second transmission piece 32, and the second connection piece 31 is screwed onto the second transmission piece 32 via the screw 206. The right-angled connection casing 2 is provided with a cavity for the transmission belt 6 to extend through. The transmission belt 6 is inserted in the cavity. The first transmission piece 42 and the second transmission piece 32 are connected by the flexible transmission belt 6 so as to achieve a linkage of the first transmission piece 42, the transmission belt 6 and the second transmission piece 32, and then achieve a linkage of the linkage piece 5, the first connection assembly 4, the transmission belt 6 and the second connection assembly 3. The first connection assembly 4 and the second connection assembly 3 are connected to the handle of the window. A person applies a force to the handle, the handle is rotated and drives the first linkage assembly 4 and the second linkage assembly 3. The handle can also be rotated in a reverse direction, and thus the first linkage assembly 4 and the second linkage assembly 3 can be driven in the reverse direction.

Further, one end of the right-angled connection casing 2 is provided with a first sliding groove along which the first transmission piece 42 may move, and the other end of the right-angled connection casing 2 is provided with a second sliding groove along which the second transmission piece 32 may move.

Further, a first shock-absorbing muffling spacer 43 is disposed at one end of the first connection piece 41 facing away from the right-angled connection casing 2 for preventing noise generated by impact or friction between the first connection piece 41 and the door or window during the movement of the first connection piece 41. A second shock-absorbing muffling spacer 33 is disposed at one end of the second connection piece 31 facing away from the right-angled connection casing 2 for preventing noise generated by impact or friction between the second connection piece 31 and the door or window during the movement of the second connection piece 31.

The working principle of the present disclosure is described as follows. The guide wheel 122 is disposed in the guide rail 502 of the window mounting frame, and the fixed base 1 and the right-angled connection casing are fixed on the window frame 501. The first connection assembly 4 and the second connection assembly 3 are connected to the handle. The connection mode of the above connection may be that: the first connection assembly 4 is connected to one end of the handle via a steel wire, and the second connection assembly 3 is connected to the other end of the handle via another steel wire. In response to determining that the handle rotates around the center thereof, the first connection assembly 4 and the second connection assembly 3 may be driven to move respectively along the first sliding groove and the second sliding groove.

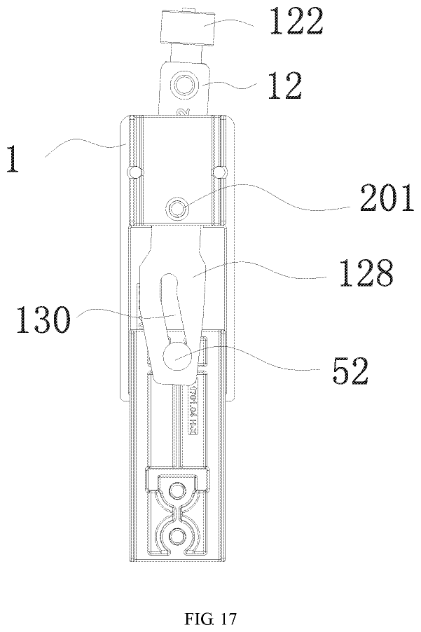

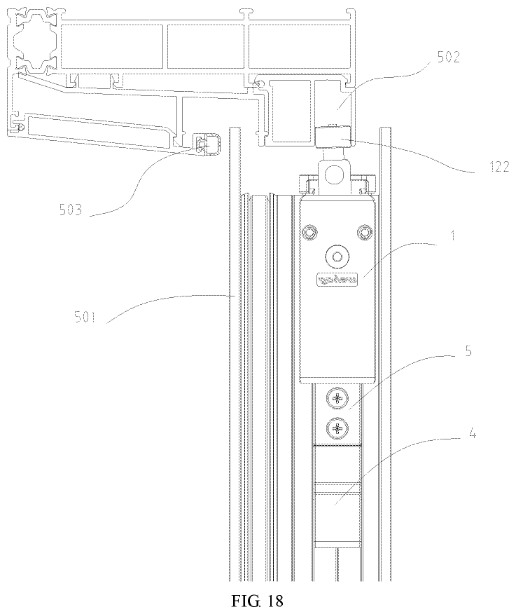

In response to determining that the window is in an unlocked state, referring to FIGS. 17 and 18, at this time the limit shaft 52 is located at the lower end of the snakelike groove 130. The sealing strip 503 is not in contact with the window frame 501, so the window may be moved at will. The door or window has the same effect as the ordinary sliding door or window.

In response to transforming the window from an unlock state to a locked state, the handle is rotated and the second connection assembly 3 is driven by the handle to move in a direction away from the right-angled connection casing 2. The second connection assembly 3 and the first connection assembly 4 are linked, so the first connection assembly 4 moves upward, the linkage piece 5 is driven by the first connection assembly 4 to move upward, and the limit shaft 52 is driven by the linkage piece 5 to move upward along the snakelike groove 130. Since the linkage piece 5 can just do linear motion, the swing piece 12 is forced to move laterally. However, the swing piece 12 and a mounting outer frame of the window are fixed in a lateral direction and cannot be movable, so relatively speaking, just the window frame 501 connected to the fixed base 1 may be moved laterally as a whole. After the lateral movement, the window frame 501 is pressed against the sealing strip 503. The window is then in the locked state.

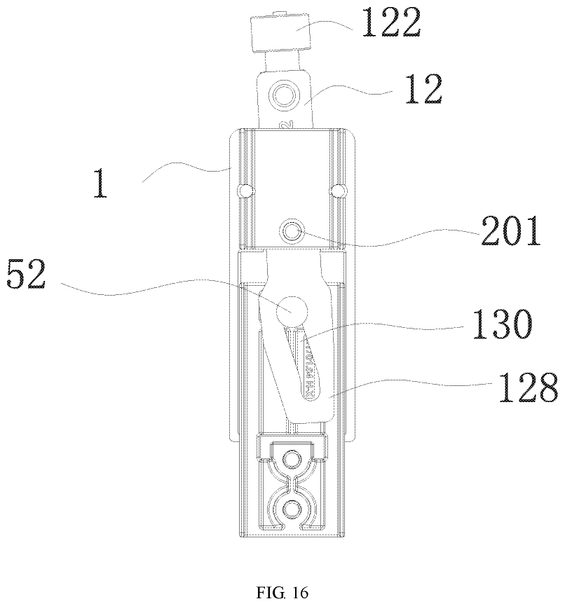

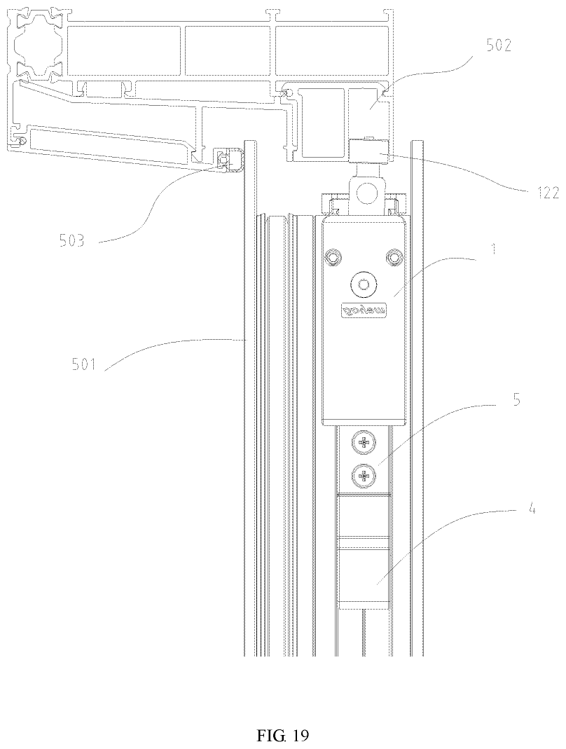

In response to determining that the window is in the locked state, referring to FIGS. 16 and 19, at this time, the sealing strip 503 is in contact with and pressed against the window frame 501, so that the window frame 501 cannot be moved. Moreover, since no gap exists between the window frame 501 and the sealing strip 503, even if receiving an external force such as wind power, the window frame 501 does not impact with the sealing strip 501 or the mounting outer frame of the window. Thus, the noise is avoided. In addition, the sealing and sound insulation effects of the window are greatly improved.

For the above-mentioned locked and unlocked states, it should be illustrated that in the unlocked state, the limit shaft 52 is not necessarily located at the lower end of the snakelike groove 13, but may be located at the upper end of the snakelike groove 130. This may be changed depending on situations.

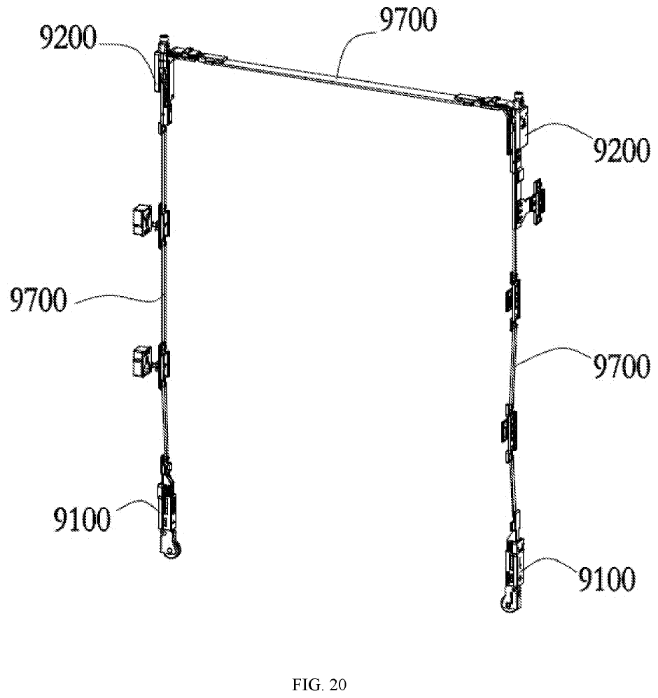

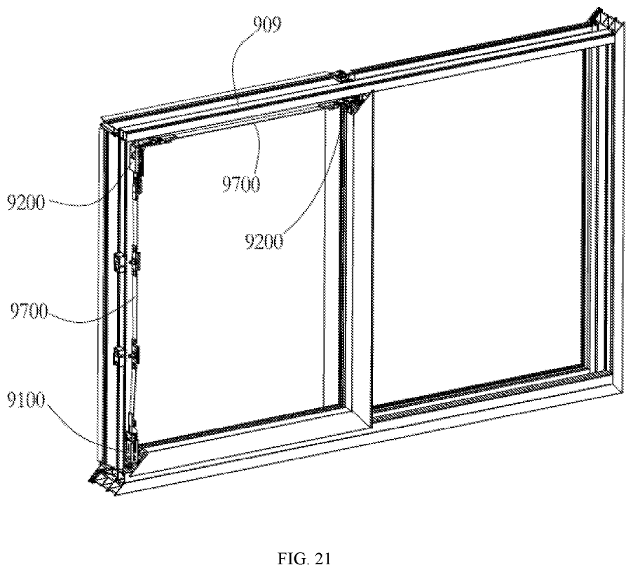

Referring to FIGS. 20 and 21, two swing fastening mechanisms 9100 are provided at the lower end of the side of the door/window frame 909, two locking structures 9200 are mounted at the upper end of the side of the door/window frame, and the two swing fastening mechanisms 9100 and the two locking structures 9200 form a linkage structure with an opening at the lower end via connection members 9700.

In the description of the specification, the description of reference terms “an implementation mode”, “some implementation modes”, “an embodiment”, “some embodiments”, “example”, “specific examples”, “some examples” or the like means a specific characteristic, structure, material or feature described in connection with the embodiment or example are included in at least one embodiment or example of the present disclosure. In the specification, the schematic representation of the above terms does not necessarily refer to the same embodiment or example. Moreover, the described specific characteristics, structures, materials or features may be combined properly in one or more embodiments or examples.

The foregoing description is merely a further detailed description of the present disclosure in connection with one or more specific embodiments. Thus, the specific implementations in accordance with the present disclosure will not be limited to the description set forth herein. Those of ordinary skill in the art to which the present disclosure pertains will be able to perform a number of simple deductions or substitutions without departing from the concept of the present disclosure.

1. A sliding door or window, comprising: a door/window frame; a swing fastening mechanism, arranged on a lower end of a side of the door/window frame; and a locking structure, mounted on an upper end of the side of the door/window frame;
wherein the swing fastening mechanism and the locking structure are each provided with a snakelike groove, and a shaft operative to slide along an orientation of the groove is arranged within the snakelike groove;
wherein a handle disposed on the door/window frame is operative to drive the shaft to slide in the snakelike groove, which forces at least one of the swing fastening mechanism or the locking structure to swing.

2. The sliding door or window of claim 1, wherein the swing fastening mechanism comprises: a base, configured to be fixedly connected to a door or window; and a pendulum member, having a lower end hinged on the base; wherein an upper end of the pendulum member is provided with a snakelike groove, a drive shaft is arranged through the snakelike groove and is slidable within the snakelike groove, the drive shaft is connected to a sliding block which has an upper end drivingly connected to the handle of the door or window and which is operative to drive the drive shaft to slide in the snakelike groove thereby forcing the pendulum member to swing around an axis of an articulated shaft, and a lower end of the pendulum member is connected to a pulley configured to be mounted on a guide rail on a lower side of the door or window;
the locking structure comprises a right-angled connection casing configured to be mounted on the door or window, a fixed base configured to be mounted on the door or window, a swing piece, a linkage piece, a first connection assembly, a second connection assembly, and at least one transmission belt;
the fixed base is provided with a first cavity body, one end of the swing piece is provided with a guide wheel configured to be mounted on the door or window and to be engaged with a guide rail on an upper side of the door/window frame, and the other end of the swing piece extends into the first cavity body of the fixed base and is hinged in the first cavity body; the end of the swing piece that extends into the first cavity body is further provided with a snakelike groove; a limit shaft movable along the snakelike groove is disposed within the snakelike groove; the linkage piece is connected to the limit shaft and is operative to move along the snakelike groove together with the limit shaft, and the moving process forces the swing piece to swing around the axis of the articulated shaft; and an end of the linkage piece facing away from the limit shaft is fixedly connected to the first connection assembly;
the right-angled connection casing is provided with a second cavity body; the transmission belt extends through the second cavity body of the right-angled connection casing, and two ends of the transmission belt are connected to the first connection assembly and the second connection assembly respectively thereby achieving a linkage of the transmission belt, the first connection assembly and the second connection assembly; and
there are two swing fastening mechanisms provided at the lower end of the side of the door/window frame, and there are two locking structures provided at the upper end of the side of the door/window frame, and the two swing fastening mechanisms and the two locking structures form a linkage structure with an opening at a lower end via a connection member.

3. The sliding door or window of claim 2, wherein the swing fastening mechanism further comprises a mounting bracket, the mounting bracket is provided with a cavity in which the pendulum member is inserted and is operative to swing to a certain extent; the mounting bracket is further provided with a straight groove extending through the cavity, two ends of the drive shaft are movably snap-fitted in the straight groove, a lower end of the sliding block is inserted into the cavity and connected to the drive shaft, and the lower end of the pendulum member extends outside of the cavity and is then connected to the pulley; the pendulum member is provided with a first hinge hole a lower end of the mounting bracket is provided with a second hinge hole, and a lower end of the base is provided with a third hinge hole, and the pendulum member, the mounting bracket and the base are connected via engagement of a rotating shaft and the three hinge holes; and
wherein in the locking structure, the swing piece comprises two identical swing plates and a square shaft disposed between the two swing plates; the swing plates are fixedly connected to the square shaft to achieve a linkage of the swing plates and the square shaft; the swing plates and the square shaft are hinged within the first cavity body of the fixed base via a rotating shaft; one end of the square shaft extends outside of the swing plates and is provided with the guide wheel configured to be mounted on the door or window; the snakelike groove is defined in one end of each of the swing plates facing away from the square shaft; and the linkage piece is further disposed between the two swing plates, and after the limit shaft extends through the linkage piece, two ends of the limit shaft are disposed in the snakelike grooves of the swing plates enabling the limit shaft move along the snakelike grooves together with the linkage piece.

4. The sliding door or window of claim 3, wherein
in the swing fastening mechanism, the lower end of the sliding block is provided with a U-shaped through groove, the upper end of the pendulum member is provided with a sheet-shaped lug operative to be inserted into the U-shaped through groove, the snakelike groove is defined on the lug, and a portion of the mounting bracket corresponding to the lug is provided with a swing window configured for ensuring a sufficient swinging travel of the lug during a swinging process;
in the locking structure, the first connection assembly comprises a first connection piece and a first transmission piece which are fixedly connected to the linkage piece; the second connection assembly comprises a second connection piece and a second transmission piece which are fixedly connected to each other; the first transmission piece and the second transmission piece are connected via the flexible transmission belt to achieve a linkage of the first transmission piece, the transmission belt, and the second transmission piece; one end of the right-angled connection casing is provided with a first sliding groove along which the first transmission piece is operative to move; and the other end of the right-angled connection casing is provided with a second sliding groove along which the second transmission piece is operative to move.

5. The sliding door or window of claim 2, wherein a mounting groove is defined at one side of the base adjacent to the pendulum member, and at least a portion of the mounting bracket is operative to be snap-fitted within the mounting groove.

6. The sliding door or window of claim 5, wherein a guide groove is defined at an upper end of one side of the base adjacent to the mounting bracket, the sliding block is provided with a guide portion configured to be snap-fitted with the guide groove, the mounting groove is located below the guide groove, and a limit structure for mate with the mounting bracket is arranged between the guide groove and the mounting groove.

7. The sliding door or window of claim 6, wherein the guide groove and the mounting groove are both square grooves and have a consistent orientation, the guide groove has a width smaller than a width of the mounting groove, the limit structure is a limit platform protruding outward from the guide groove, the mounting bracket is in a quadrilateral cylindrical shape and has a side surface abutting against a bottom of the mounting groove so as to be fitted with the base, and one end of the mounting bracket abuts against a boss protruding outward from the guide groove.

8. The sliding door or window of claim 2, wherein the pulley is mounted at the lower end of the pendulum member via a bracket.

9. The sliding door or window of claim 5, wherein within the mounting groove is provided a receiving groove, which has a substantially the same length as the straight groove and is configured for one end of the drive shaft to slide in.

10. The sliding door or window of claim 2, wherein the sliding block is provided with a shock-absorbing muffling spacer; and a first shock-absorbing muffling spacer is disposed at one end of the first connection assembly facing away from the right-angled connection casing, and a second shock-absorbing muffling spacer is disposed at one end of the second connection assembly facing away from the right-angled connection casing.

11. The sliding door or window of claim 2, wherein the pulley is a U-shaped groove wheel made of an elastic material, and the transmission belt is a flexible steel belt.

12. The sliding door or window of claim 3, wherein a mounting groove is defined at one side of the base adjacent to the pendulum member, and at least a portion of the mounting bracket is operative to be snap-fitted within the mounting groove.

13. The sliding door or window of claim 4, wherein a mounting groove is defined at one side of the base adjacent to the pendulum member, and at least a portion of the mounting bracket is operative to be snap-fitted within the mounting groove.

14. The sliding door or window of claim 3, wherein the pulley is mounted at the lower end of the pendulum member via a bracket.

15. The sliding door or window of claim 4, wherein the pulley is mounted at the lower end of the pendulum member via a bracket.

16. The sliding door or window of claim 3, wherein the sliding block is provided with a shock-absorbing muffling spacer; and a first shock-absorbing muffling spacer is disposed at one end of the first connection assembly facing away from the right-angled connection casing, and a second shock-absorbing muffling spacer is disposed at one end of the second connection assembly facing away from the right-angled connection casing.

17. The sliding door or window of claim 4, wherein the sliding block is provided with a shock-absorbing muffling spacer; and a first shock-absorbing muffling spacer is disposed at one end of the first connection assembly facing away from the right-angled connection casing, and a second shock-absorbing muffling spacer is disposed at one end of the second connection assembly facing away from the right-angled connection casing.

18. The sliding door or window of claim 6, wherein the sliding block is provided with a shock-absorbing muffling spacer; and a first shock-absorbing muffling spacer is disposed at one end of the first connection assembly facing away from the right-angled connection casing, and a second shock-absorbing muffling spacer is disposed at one end of the second connection assembly facing away from the right-angled connection casing.

19. The sliding door or window of claim 3, wherein the pulley is a U-shaped groove wheel made of an elastic material, and the transmission belt is a flexible steel belt.

20. The sliding door or window of claim 4, wherein the pulley is a U-shaped groove wheel made of an elastic material, and the transmission belt is a flexible steel belt.
